(19) United States
(12) Patent Application Publication
(10) Pub. No.: US 2005/0226968 A1
(43) Pub. Date: Oct. 13, 2005

(54) Vegetable casing and the production method thereof

(76) Inventors: Pierre Holzschuh, Kehl (DE); George Wolfgang Buch, Schutterward (DE); Jean-Jacques Weiland, Illkirch Grattenstaden (FR); Anne Metzger, Andlau (FR)

Correspondence Address: YOUNG & THOMPSON, 745 SOUTH 23RD STREET, 2ND FLOOR, ARLINGTON, VA, 22202, US

(21) Appl. No.: 10/508,257

(22) PCT Filed: Feb. 18, 2003
(86) PCT No.: PCT/FR03/00536

§ 371 Date: Jun. 13, 2005

(30) Foreign Application Priority Data
Mar. 19, 2002 (FR) 02/03395

(51) Int. Cl. A21D 13/00

(52) U.S. Cl. 426/138

(57) ABSTRACT

The invention relates to a vegetable casing and a production method thereof. The inventive casing is characterised in that it essentially comprises a matrix of non-water-soluble alginates which is reinforced with vegetable fibres or polysaccharides in order to increase the mechanical and thermal resistance thereof. The invention is suitable for use in the agri-food industry and, in particular, for transforming meat products into delicatessen products, such as foodstuff casings for sausages.

The present invention relates to the field of agri-food industry, in particular the transformation of wheat products into delicatessen products and particularly edible casings for sausages, and has for its object a vegetable casing.

The invention also has for an object a process for the production of such a casing.

At present, edible tubular casings, commonly called food casings, are widely used for the production of a large number of meat-based food products, such as sausages and the like. The casings of this type are generally constituted in the form of tubes for the thin wall of different diameters, as a function of their final use and are, either of animal origin, or artificial.

When these casings are of animal origin, their diameter is simply a function of the diameter of the original casing. Recent problems of food safety posed by the risk of transmission of certain diseases by animal viscera have however seriously limited the use of these casings.

As to the use of artificial casings, most often used as a substitute for natural casings, their diameter can be exactly adapted to the type of product to be produced.

However, these latter often have the drawback of only imperfectly satisfying the criteria of quality of the consumer, namely the retention of the surface aspect and taste, which are essential to the commercial success of the final products.

The artificial casings now available on the market are generally constituted by a mixture of alginates or of cellulose derivatives.

Thus there is known, from GB-A-703 859, a process for the production of a food casing based on alginates, whilst U.S. Pat. No. 3,135,613 discloses a process for obtaining cellulosic films from paper treated by the viscose process. In this process, the food film is constituted by a paper core, which is then impregnated with an alkali solution of viscose containing, among other things, cellulose xanthate. The obtained film is then treated with an acid coagulant solution. There results a precipitation of the cellulose xanthate, soluble in alkaline solution, in contact with the acid. A film of regenerated cellulose hydrate is finally obtained by treatment of the film with an acid regenerating solution.

The reinforced cellulose films thus obtained by the viscous process however have relatively mediocre mechanical properties and hence the drawback of risking bursting, even when the internal pressures are low.

Moreover, GB-A-1 091 105 discloses a process in which a cellulosic starting film contains a cross-linked synthetic resin of polyamide base. The film obtained after the use of the viscous process has improved mechanical performance but which is however insufficient for certain delicatessen applications.

U.S. Pat. No. 5,143,584 has for its object a process for preparation, in which soluble alginates are added to the paper paste before the formation of the sheet of paper. This latter is then formed and dried before the application of an alginate precipitation agent in its non-hydrosoluble form. The precipitation agent used is constituted by a dilute sulfuric acid solution and is applied in the form of a spray on the sheet of paper.

There is also known from U.S. Pat. No. 5,662,971, a process for obtaining a food casing that is alginate based, of fatty bodies and cellulose, in which the food casing is present in the form of a film adapted to enclose food products. Finally, the association of alginates and proteins, to form a food casing, is also disclosed in WO-A-9955165.

EP0 733 306 discloses the production of an artificial casing by the viscous process. This process uses a “cellulose armature” combination and then “precipitation of cellulose xanthate”.

In this type of process, the food film is formed before use and this film is placed in contact with the food product in a step independent of the process of production of the final product.

All the above documents permit obtaining food films composed of cellulose reinforced by alginates. However, none discloses a process adapted to create a food film directly in contact with the product to be treated.

Moreover, GB-A-500 242 discloses the production of a food casing composed of vegetable or artificial fibers (obtained by disintegration of skin, tendons, wool or hair), the mixture of the components used is provided with an addition of plastifiers to permits its extrusion into a casing. A mechanical reinforcement is used by the addition of hardening agents, such as tannins.

Finally, there is also known from WO 02 15715 a process for the production of a casing based on alginate, pectin or carragenan and galactomanane. This casing is produced by co-extrusion with the help of a gel and is formed, following precipitation of the gel, in a fixing bath. This processes uses a second polysaccharide, namely guar and carob gum, which is used to adjust the viscosity of the gel, without however permitting mechanical reinforcement of the obtained film.

This process does not permit obtaining an improvement in the strength of the casing upon cooking.

The present invention has for its object to overcome these drawbacks by providing a vegetable casing and a process for production of such a casing, permitting obtaining mechanical characteristics, namely mechanical resistance, elasticity and texture, comparable to those of a natural animal casing.

To this end, the vegetable casing is characterized in that it is essentially constituted by a matrix of alginates that are non-hydrosoluble, reinforced with vegetable or polysaccharide fibers, so as to increase the mechanical and thermal resistance of said casing.

The invention also has for its object a process for the production of this casing, characterized in that it consists essentially in effecting a preliminary cladding of a food product with the help of a bath of a film forming solution containing a hydrosoluble alginate and vegetable or polysaccharide fibers, then in fixing the film obtained by precipitation of the alginate in a non-hydrolyzable form in fixing baths.

The composition of the film forming the casing is 5 to 95% alginates and 95 to 5% vegetable or polysaccharide fibers and, preferably, 30 to 70% alginates and 70 to 30% of vegetable or polysaccharide fibers.

The alginic acids are vegetable polysaccharides containing numerous carboxyl groups and the alginates are conjugated salts of these alginic acids. The alginates are generally extracted from brown algae and have a chemical structure near that of cellulose. They are constituted by long linear chains, largely substituted with carboxyl groups. These latter permit easily fixing water molecules by hydrogenic connection and have the extremely hydrophilic characteristic of alginic acids and alginates.

According to the invention, the alginates used are hydrosoluble in aqueous suspensions of vegetable fibers and precipitate under the action of a fixing bath.

The fixing baths used are preferably constituted by calcium salts causing the precipitation of non-hydrolyzable calcium alginate and/or by acid baths leading to the precipitation of non-hydrolyzable alginic acid.

Preferably, the initial solution of hydrosoluble alginate and fibers contains 0.05% to 50% alignate and 0% to 80% of vegetable fibers.

According to one characteristic of the invention, the food film forming the casing is flavored and/or colored by the addition of flavorings and/or coloring agents in the cladding or fixing solution.

Thus, the flavoring of the food film can be carried out with flavors or smoke extracts.

The coloring of the food film can be effected by Maillard reactions, by conjugation of acid amines or any other amine and of reducing sugars or carbonyls present in the cladding or fixing solution.

According to another characteristic of the invention, the pH of the fixing bath is suitably comprised between 1 and 7 and is preferably comprised between 2 and 4. The pH of the fixing bath, as well as the initial compositions of alginates and fibers and the chemical nature of the fixing bath or baths, have an influence on the final properties of the obtained food film.

These influences are described hereafter with respect to Examples 1 to 5.

### EXAMPLE 1

In this example, different compositions of cladding bath and fixing bath have been tested.

The following cladding baths have been produced:
Alginates known under the commercial name FD 175 of the DANISCO company, in a solution of 1.5% by weight in soft water.
Alginates FD 175 in a solution of 1.5% by weight in soft water and fibers of cellulose known by the name VITACEL WF 200 of the RETTENMAIER company, in a solution of 1% by weight in soft water
Alginates FD 175 in solution at 1.5% of weight in soft water and fibers of cellulose known by the name GEMTEC 300 of the BRYAN W. NASH & SONS LTD company, in solution at 1% by weight in soft water
Alignates FD 175 in a solution of 1.5% by weight in soft water and fibers of VITACEL WF 200 cellulose in solution at 0.5% by weight in soft water and fibers of GEMTEC 300 cellulose in solution at 0.5% in soft water
Pectin known by the name PECTIN AMID CF 020 of the GIKA company, in solution at 3% by weight in soft water.

The fixing baths used are:
CaCl₂ in solution at 10% by weight in a water/ethanol 50/50 solution
CaCl₂ in solution at 10% by weight in a water/ethanol 25/75 solution
CaCl₂ in solution at 10% by weight in a pure ethanol solution.

All of the food films obtained have a brilliant transparent appearance, except those obtained by combining alginate with the vegetable fibers VITACEL WF 200, the appearance obtained with this latter being transparent matte and hence very near that of casings of natural animal origin.

The food film covers homogeneously the food product, however, the pectin based film has a high fragility and, in places, holes. The use of cellulose fibers of the GEMTEC 300 type gives rise to the appearance of fine air bubbles in the food envelope.

Moreover, it has been noted that the drying kinetic of the film increases with the concentration of alcohol in the fixing bath. Thus, for the film based on FD 175 alginates in solution at 1.5% by weight and of VITACEL WF 200 in solution at 1% by weight, an optimum drying is obtained by a combination with fixing baths of water/ethanol in a ratio of 25/75, and pure ethanol.

The food products obtained which were in the form of sausage have been cooked on a grill and have permitted noting that the films based on alginate FD 175 in solution at 1.5% by weight and VITACEL WF 200 in solution at 1% by weight, as well as based on alginates FD 175 in solution at 1.5% and GEMTEC 300 in solution at 1% by weight, forming casing thus produced, have a good mechanical resistance and good adhesion to the product.

### EXAMPLE 2

It has been attempted to adapt the viscosity of the cladding bath to various uses comprising cladding by spraying, drenching or co-extrusion.

The cladding solutions used were the following:
Alginates FD 175 in solution at 1.5% by weight in soft water and fibers of cellulose VITACEL WF 200 in solution at 1% by weight in soft water
Alginates FD 175 in solution at 2% by weight in soft water and fibers of cellulose VITACEL WF 200 in solution at 1.34% by weight in soft water
Alginates FD 175 in solution at 3% by weight in soft water and fibers of cellulose VITACEL WF 200 in solution at 2% by weight in soft water
Alginates FD 175 in solution at 4% by weight in soft water and fibers of cellulose VITACEL WF 200 in solution at 2.67% by weight in soft water
Alginates FD 175 in solution at 6% by weight in soft water and fibers of cellulose VITACEL WF 200 in solution at 4% by weight in soft water.

The fixing bath used is a bath of CaCl₂, diluted to 10% by weight in a water/ethanol 25/75 solution.

It has been noted that the viscosity of the cladding bath increases with the concentration in alginates and in vegetable fibers. It is thus possible to carry out an adjustment of the viscosity of the cladding solution for each type of use by spraying, by drenching or by co-extrusion. Moreover, the mechanical properties of the food films obtained increase with the concentration of alginates and in vegetable fibers. Finally, for high concentrations of alginates and vegetable fibers, there is also obtained a variation of the color toward a yellowing color and an opaque tint.

### EXAMPLE 3

To study the influence of pH of the fixing bath or baths used, the fixing baths based on aqueous solutions of 10% of CaCl₂, at different pHs, have been used. The pH has been adjusted with the help of a citric acid solution; however, any other means of adjustment of this type is usable.

The fixing baths used were the following:
pH=6.35
pH=5.1
pH=4.3
pH=3.1

The food films, forming the casing, obtained with acid pH have an improved mechanical resistance and/or more wrinkle than those obtained with neutral pH. Thus, at a pH of 3.1, the films have a more tense texture, more firm and more resistant. The acid pH permits the precipitation of a portion of the alginates in the form of alginic acid. The combination of the two modes of precipitation, namely in the form of calcium alginate and alginic acids, permits refining the final texture of the food film.

### EXAMPLE 4

The food casing obtained, forming the artificial casing, has been used for the production of sausage of the spicy type, namely containing 25% beef and 75% lean mutton meat and of the chipolatas type which is pork based.

The quenching bath used was constituted by alginates FD 175 in solution at 2% by weight and VITACEL WF 200 in solution at 1.34% by weight and the fixing bath was a bath of CaCl₂ at 10% by weight in a water/ethanol 50/50 solution with a pH of 3.

The gain of weight of the treated spicy sausage is set forth in the following table:

| | Spicy sausage No. | | | | |
|---|---|---|---|---|---|
| | 1 | 2 | 3 | 4 | 5 |
| Weight | 62.6 | 64.5 | 56.6 | 40.0 | 58.7 |
| before | | | | | |
| cladding | | | | | |
| (g) | | | | | |
| Weight | 68.2 | 71.5 | 62.5 | 47.0 | 66.2 |
| after | | | | | |
| cladding | | | | | |
| (g) | | | | | |
| Gain in % | 9.0 | 10.8 | 10.5 | 17.5 | 12.8 |

It has been noted that the food film distributes itself homogeneously about the sausage, is very resistant, and has a matte appearance. The duration of contact of the clad sausage with the fixing bath has an influence on the rigidity of the final food film obtained. Thus, the longer the contact with the fixing bath, the more rigid the film becomes.

The sausages were then cooked on a grill and the strength after cooking of the products obtained have been compared with that of the comparison products comprising a food envelope constituted by natural animal casings, and their characteristics are given in the following table:
A: Spicy sausage with natural animal casing
B: Spicy sausage left 30 seconds in contact with the fixing bath

C: Spicy sausage left 300 seconds in contact with the fixing bath

| | Spicy sausage No. | | |
|---|---|---|---|
| | A | B | C |
| Weight before | 62.4 | 45.3 | 62.0 |
| cooking (g) | | | |
| Weight after | 47.8 | 33.9 | 52.0 |
| cooking (g) | | | |
| Loss of | 23 | 25 | 16 |
| weight (%) | | | |

The food film obtained with spicy sausage C has a resistant to cooking greater than that of spicy sausage A whose food envelope is constituted by a natural animal casing. Spicy sausage C has a texture and a crunch similar to that of spicy sausage A.

### EXAMPLE 5

This example describes an industrial process, in which 50 kg of chipolatas meat at a temperature of −5° C. is used for the production of sausages. A former and industrial cladder known by the commercial name Koppens of the CONVINENCE FOOD company was used for this purpose.

The cladding bath used was the following:
Alginates FD 175 in solution at 1.6% in soft water and VITACEL WF 200 in solution at 0.8% in soft water.

The fixing bath was an aqueous solution of 10% by weight of CaCl₂ with a pH of 3.

The cladding of the food film was carried out by the passages of the sausages below a gel screen, the sausages being then directed below an air blower before being collected in the fixing bath, where they were kept for 3 minutes.

The sausages obtained were cooked the same day and their resistance to cooking was observed, as well as good adhesion of the film on the product during cooking. The food film obtained moreover had an excellent resistance to tearing.

This test permitted the conclusion that the use of industrial machines is thus possible, the mechanical properties of the obtained film being similar to, or even superior to, those of natural casings of animal origin. The texture and the surface properties of the obtained casings are identical to those of natural animal origin.

Thanks to the invention, it is possible to produce a vegetable casing that can advantageously replace a natural casing, this casing being obtained by cladding the food product. The film forming the casing has characteristics in terms of texture and mechanical properties identical to those of a natural casing.

Moreover, this vegetable casing also has a good resistance to cooking, adhesion to the product and aptitude for swelling necessary for the treatment of products containing food casings.

Of course, the invention is not limited to the disclosed embodiment. Modifications remain possible, particularly as to the constitution of the aqueous solutions used, without thereby departing from the scope of protection of the invention.

1. Vegetable casing characterized in that it is essentially constituted by a matrix of non-hydrosoluble alignates reinforced by vegetable or polysaccharide fibers, so as to increase the mechanical and thermal resistance of said casing.

2. Casing according to claim 1, wherein the composition of the film forming the casing is 5 to 95% by weight alginates and 95 to 5% by weight vegetable or polysaccharide fibers.

3. Casing according to claim 2, wherein the composition of the film forming the casing is 30 to 70% by weight alginates and 70 to 30% by weight vegetable or polysaccharide fibers.

4. Process for the production of a vegetable casing according to claim 1, which consists essentially in carrying out a preliminary cladding of a food product with the help of a bath of a film forming solution containing a hydrosoluble alginate and vegetable or polysaccharide fibers, then in fixing the film obtained by precipitation of the alginate in a non-hydrolyzable form in a fixing bath.

5. Process according to claim 4, wherein the alginates used are hydrosoluble in aqueous suspensions of vegetable fibers and precipitate under the action of a fixing bath.

6. Process according to claim 4, wherein the fixing baths used are constituted by calcium salts causing the precipitation of non-hydrolyzable calcium alginate and/or by acid baths causing the precipitation of non-hyrosoluble alginic acid.

7. Process according to claim 4, wherein the initial solution of hydrosoluble alginate and fibers contains 0.05% to 50% by weight of alginate and 0% to 80% by weight of vegetable fibers.

8. Process according to claim 4, wherein the food film forming the casing is flavored and/or colored by the addition of flavorings and/or colorings in the cladding or fixing solution.

9. Process according to claim 4, that wherein the pH of the fixing bath is comprised between 1 and 7.

10. Process according to claim 4, wherein the pH of the fixing bath is comprised between 2 and 4.
